(19) United States
(12) Patent Application Publication
(10) Pub. No.: US 2002/0178564 A1
(43) Pub. Date: Dec. 5, 2002

(54) Separating tool and method of using same

(76) Inventor: William M Crawford, Glen St. Mary, FL (US)

Correspondence Address: Jeffrey C. Maynard, 325 Creswell Road, Severna Park, MD, 21146, US

(21) Appl. No.: 09/867,161

(22) Filed: May 29, 2001

(51) Int. Cl. B23P 19/04

(52) U.S. Cl. 29/426.5; 29/239

(57) ABSTRACT

A separator tool specifically designed for pressure fitted bearings, sprockets, pulleys and flanges is disclosed. The separator tool is threaded and presents a ball bearing on one end and a means to rotate the tool on another end. The ball bearing is held in place by a magnet to permit ease of rotation without loss of such ball bearing. Rotating means can be a conventional hexagonal bolt head.

### BACKGROUND OF THE INVENTION

1. Field of the Invention

The present invention relates to separating tools, and in particular, the invention relates to a threaded device for use in separating mechanical parts such as sprockets, pulleys, and pressure fitted bearings. This invention relates generally to a replacement tool for separating mechanical parts or removing pressure fitted parts in place of a standard bolt.

2. Background of the Prior Art

In the repair of automobiles, aircraft and other mechanical devices, it is often necessary to use special tools to forcibly separate one mechanical component from another. For example, in order to remove a gear from the shaft upon which it rotates, a tool known as a gear puller is used. These pullers have typically included a yoke and a large threaded bolt that passes through the center of the yoke. The threaded bolt typically presses against a flat component of the puller device.

Other applications similarly use a threaded bolt, which passes through a threaded bore, the end of the bolt pressing against a surface to move a piece by rotating the bolt using the mechanical advantage of the threaded portion.

The force generated in such applications is applied at the end of the bolt where a tremendous amount of friction resists rotation of the bolt. In most applications, the end of the bolt is substantially flat, although sometimes the bolt end is projected in a conical shape to minimize friction.

A need exists for a separating tool that is intended to be used in puller assemblies and other applications, that is inexpensive and simple to assemble, and that provides a frictionless surface for applying force. There is a need for strong separator tool that can be used for heavy duty machine applications and replace threaded bolts in puller assemblies.

### SUMMARY OF THE INVENTION

The present invention fulfills these needs. A compact separator tool with a ball bearing integrated into one end enables smooth operation that is substantially friction free.

An object of this invention is to provide a tool, which is capable of being manufactured at a substantially low cost.

It is another object of the present invention to provide a tool which requires significantly less force to operate and achieving applied tasks with less danger to the mechanic and less wear on the tool and the parts to be removed.

It is a further object of the present invention to enable a separating tool that is sturdy enough to withstand substantial compression force, yet lightweight enough for easy assembly and storage.

Another object is to enable a separating tool that presents a substantially frictionless bearing.

In a preferred embodiment, a separating tool is provided that has a use in industrial and manufacturing machinery processes. The tool is not limited to such uses. The tool is used in the separating process for such components as sprockets, pulleys, bearing housing and the like. Such components may be installed on a shaft as a pressure fitted unit or installed as two pieces and then pulled together at a specific position using fasteners, such as nuts and bolts.

When maintenance or repair deems it necessary to remove such components, the separator tool described herein can be employed. First, the fasteners are removed, and then the separator tool is inserted in an available aperture to apply pressure to an opposing piece, which will induce separation and enable the component to be removed.

The separator tool consists of a hardened steel threaded rod, such as a bolt or other elongated piece able to be rotated about its central axis, of sufficient diameter to permit a void to be drilled partly into the longitudinal axis at a first end. A stick magnet is embedded in such void. A substantially spherical concave section is carved from such first end to enable a single ball bearing to ride in such concave section, being held in place by such magnet. The remaining end of such threaded rod presents a standard size hexagonal configuration or other appropriate handle to permit rotational force to be applied to such rod.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 is a general arrangement view of one embodiment of a separator tool according to the present invention;

FIG. 2 is an exploded view of the separator tool of FIG. 1, partially in perspective, to show component parts according to of one embodiment of the present invention; and

FIG. 3 is a cross-sectional view of a separator tool, taken along a plane indicated by interrupted line 3-3 of FIG. 1, for describing selected characteristics of an embodiment of the invention.

### DETAILED DESCRIPTION OF THE INVENTION

The invention summarized above and defined by the enumerated claims may be better understood by referring to the following detailed description, which should be read in conjunction with the accompanying drawings in which like reference numbers are used for like parts. This detailed description of an embodiment, set out below to enable one to build and use an implementation of the invention, is not intended to limit the enumerated claims, but to serve as a particular example thereof. Those skilled in the art should appreciate that they may readily use the conception and specific embodiment disclosed as a basis for modifying or designing other methods and systems for carrying out the same purposes of the present invention. Those skilled in the art should also realize that such equivalent assemblies do not depart from the spirit and scope of the invention in its broadest form.

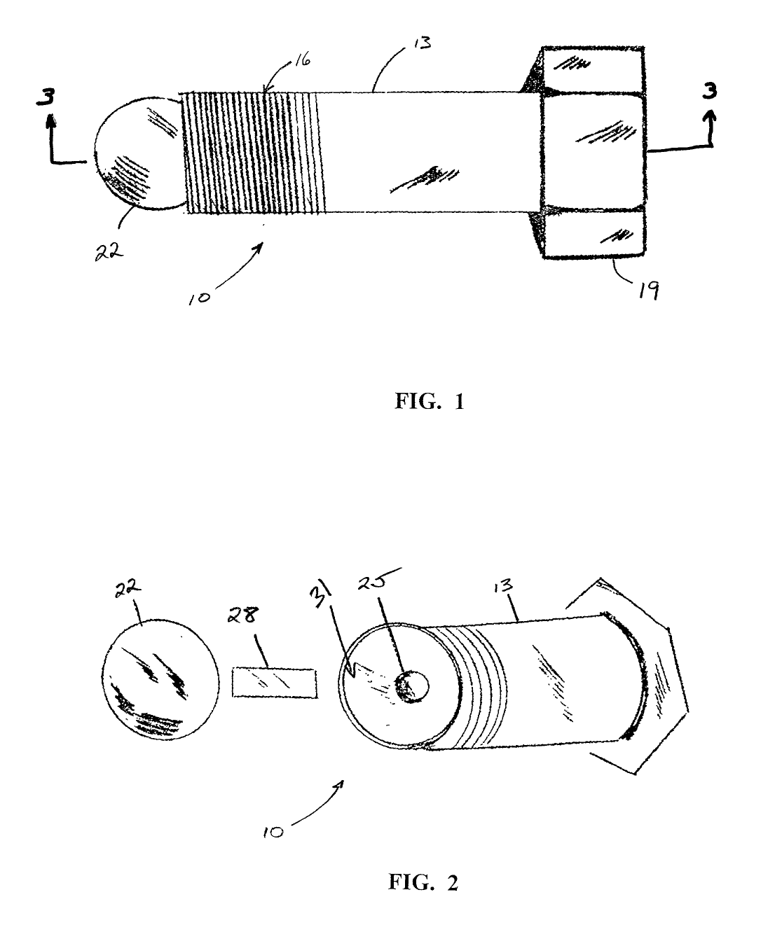

Referring to FIG. 1, separator tool 10 is illustrated having a shaft 13 presenting a substantially cylindrical configuration with a threaded portion 16 on a first end and a hexagonal head 19 at its remaining end. Shaft 13 may be fabricated of medium grade steel, such as used to manufacture bolts. Separator tool 10 has a substantially spherical ball 22, such as a ball bearing partially embedded in the threaded end of shaft 13.

Referring to FIG. 2, there is an exploded view of separator tool 10 to show component parts of such tool for describing a particular embodiment of the present invention

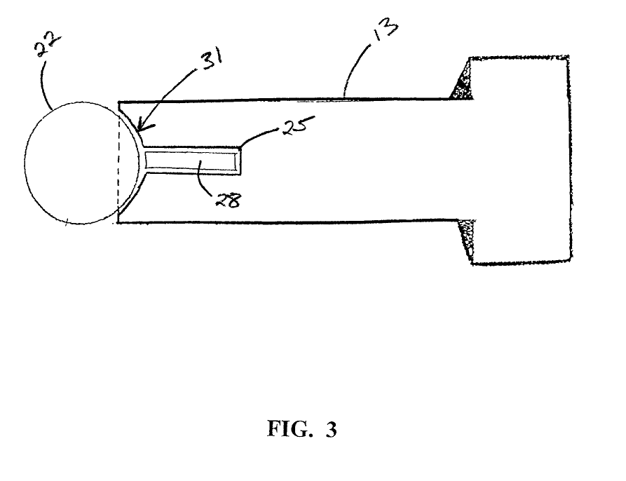

Shaft 13 presents a hollowed out void 25 in the first end into which is placed a substantially cylindrical permanent magnet 28, preferably sized to fit snugly within void 25, and of sufficient magnetic strength to hold ball 22. The length of permanent magnet 28 should be approximately equal to the depth of void 25, as illustrated and described with reference to FIG. 3. The first end of shaft 13 also presents a substantially concave depression 31, the radius of which is substantially the same as ball 22.

FIG. 3 is a cross-sectional view of a separator tool illustrating a specific embodiment of the present invention. Concave depression 31 is carved into the first end of shaft 13. Void 25 is drilled into shaft 13 a sufficient depth to hold permanent magnet 28. Such permanent magnet 28 is inserted in void 25, and then ball 22 is placed in depression 31, being held in place by permanent magnet 28.

In operation, separator tool 10 is inserted in a threaded aperture, specifically arranged on a preselected component for separating purposes. Tool 10 is rotated to engage threads 16 and drive into the aperture. When tool 10 reaches the bottom of such aperture, the tool is continued to rotate thereby forcing separation of such component.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

While specific values, relationships, materials and steps have been set forth for purposes of describing concepts of the invention, it should be recognized that, in the light of the above teachings, those skilled in the art can modify those specifics without departing from basic concepts and operating principles of the invention taught herein.

What is claimed is:

1. A separator tool, comprising:
a rod having a first end and a second end,
(A) having at least a portion of such rod presenting mechanical threads on such first end;
(B) having a ball bearing detachably connected to such first end, with
(C) means for connecting such ball bearing to such rod, and
(D) means for rotating such rod about its longitudinal axis on such second end.

2. The separator tool of claim 1, further comprising:
(A) a concave depression in such first end of such rod in which such ball bearing is detachably connected.

3. The separator tool of claim 1, in which such means for connecting such ball bearing to such rod comprises magnetic means.

4. The separator tool of claim 3, further comprising:
(A) a void presented in such first end of such rod for receiving such magnetic means.

5. The separator tool of claim 1, in which such means for rotating such rod about its longitudinal axis comprises a bolt head.

6. The separator tool of claim 1, in which such means for rotating such rod about its longitudinal axis comprises a handle.

7. Method of separating mechanical components, comprising the steps of:
(A) providing a separator tool, comprising:
a rod having a first end and a second end,
(i) having at least a portion of such rod presenting mechanical threads on such first end;
(ii) having a ball bearing detachably connected to such first end, with
(iii) means for connecting such ball bearing to such rod, and
(iv) means for rotating such rod about its longitudinal axis on such second end;
(B) inserting such separator tool in an aperture provided for separating such mechanical components;
(C) rotating such separator tool about its longitudinal axis until it reaches the bottom of such aperture; and
(D) further rotating such separator tool about its longitudinal axis to effect separation of such mechanical components.
